(19) United States
(12) Patent Application Publication
(10) Pub. No.: US 2015/0160031 A1
(43) Pub. Date: Jun. 11, 2015

(54) METHOD AND SYSTEM FOR MANEUVER-LEVEL CONTEXTUAL FILTERS IN DIRECTIONS

(71) Applicants: Andrew Eland, London (GB); Hsun Tang, Shanghai (CN); Judith Shade, Tokyo (JP); Audrey Ya-Jun Yang, San Francisco, CA (US); Jens Riegelsberger, London (GB)

(72) Inventors: Andrew Eland, London (GB); Hsun Tang, Shanghai (CN); Judith Shade, Tokyo (JP); Audrey Ya-Jun Yang, San Francisco, CA (US); Jens Riegelsberger, London (GB)

(73) Assignee: GOOGLE INC., Mountain View, CA (US)

(21) Appl. No.: 13/469,974

(22) Filed: May 11, 2012

(51) Int. Cl. G01C 21/00; G01C 21/36; G06F 17/30; G06F 3/0484

(52) U.S. Cl. CPC G01C 21/36; G06F 17/30241; G06F 3/04842

(57) ABSTRACT

In a general aspect, a method for modifying a geographic route from a starting location to a destination location can include, responsive to a search query, presenting a graphical user interface including a depiction of a route including a series plurality of sequential maneuvers from the starting location to the destination location, where at least one of the series plurality of sequential maneuvers is associated with one or more selectable visual attributes that correspond with static or real-time conditions. The method can also include, automatically retrieving a refined route upon a selection of a first selectable visual attribute of the one or more selectable visual attributes, the refined route having a maneuver of the plurality of sequential maneuvers corresponding with the first selectable visual attribute replaced with one or more different maneuvers and, upon automatically retrieving the refined route, presenting the refined route in the graphical user interface.

### FIELD

This disclosure generally relates to methods and systems for geographic routes, and more specifically, to modifying geographic routes using graphical user interfaces.

### BACKGROUND

Constraint-based geographic routing systems often use a series of check-boxes (e.g., “avoid buses”) that must be selected before a route is calculated. Often, these series of check-boxes are only available, if at all, from a hidden “advanced settings” area of a user interface.

This approach has a number of shortfalls. For example, a user is required to click through to the “advanced settings” area of the user interface to select the constraints prior to conducting a search for a geographic route. Another issue is that the user has to make choices from a large number of constraints before any particular route is calculated, so the user may pick from choices that are not available for or not relevant to the particular search. Further, information about constraints is not usually shown in a route unless selected by the user before the search, so the user may have no way of knowing which constraints apply to any particular route from simply viewing a calculated route. Thus, a need exists for systems, methods, and apparatus to address the shortfalls of present technology and to provide other new and innovative features.

### SUMMARY

According to one general aspect, a method for modifying a geographic route is disclosed. Responsive to a search query for the geographic route, a graphical user interface is presented including a depiction of a route including a series of maneuvers, at least one of the series of maneuvers associated with one or more selectable visual attributes. The one or more selectable visual attributes are associated with predetermined attributes not included in the search query. The predetermined attributes include static or real-time conditions. The route is automatically refined upon a selection of a first selectable visual attribute of the one or more selectable visual attributes. Upon automatically refining the route, the refined route is presented in the graphical user interface.

Various implementations are contemplated. For example, the real-time conditions may include a weather condition, a congestion level, or a delay. The static conditions may include a mode, a level change, a fee, or a track condition for a local public transit system. In various implementations, the real-time conditions may be automatically updated in the graphical user interface after a predetermined period of time. Each of the predetermined conditions may occur within a predefined radius of an associated one of the series of maneuvers. Further, the refined route may be displayed in the graphical user interface without additional input from a user. In various implementations, the method also includes automatically refining the refined route upon a selection of a second selectable visual attribute of the one or more selectable visual attributes, and upon automatically refining the refined route, presenting the refined route in the graphical user interface.

The depiction of the route may include a map displaying the series of maneuvers. In various implementations, the series of maneuvers may be concurrently displayed in a text format adjacent the map. The selectable visual attributes may, in certain implementations, be selectable by at least one of: a drop down menu, a button, a slider, or a touch-screen gesture. Each of the one or more selectable visual attributes may, in some implementations, include an option to avoid a maneuver associated with the one or more selectable visual attributes. Automatically refining the route may include generating the refined route to exclude a maneuver associated with the first selectable visual attribute. Automatically refining the route may also include automatically submitting a search query to a remote server, based on manual input from a user via a graphical user interface (e.g., a user selection of selectable attributes), and automatically receiving a new route from the remote server, in response to the query. The route may be calculated without including any predetermined constraints selected by a user. The selectable visual attributes may include graphical icons. Each of the one or more selectable visual attributes may include an option to exclude a type of static or real-time condition associated with the one or more selectable visual attributes. The series of maneuvers may include a maneuver for a local public transit system, and the static or real-time conditions depend on the type of local public transit system.

According to another general aspect, a non-transitory computer readable medium has recorded and stored thereon instructions that, when executed by a processor of a computer system, cause the computer system to: responsive to a search query for a geographic route, present, using a processor of the computing device, a graphical user interface including a depiction of a route including a series of maneuvers, each of the series of maneuvers associated with one or more selectable visual attributes, wherein the one or more selectable visual attributes are associated with predetermined attributes not included in the search query, wherein the predetermined attributes include static or real-time conditions; automatically refine the route upon a selection of a first selectable visual attribute of the one or more selectable visual attributes; and upon automatically refining the route, present the refined route in the graphical user interface.

According to yet another general aspect, a system includes a display, a memory configured to store executable code, and a processor operably coupled to the memory. The processor is configured to execute the code to: responsive to a search query for a geographic route, present on the display a graphical user interface including a depiction of a route including a series of maneuvers, each of the series of maneuvers associated with one or more selectable visual attributes, wherein the one or more selectable visual attributes are associated with predetermined attributes not included in the search query, wherein the predetermined attributes include static or real-time conditions; automatically refine the route upon a selection of a first selectable visual attribute of the one or more selectable visual attributes; and upon automatically refining the route, present the refined route in the graphical user interface.

The details of one or more implementations are set forth in the accompanying drawings and the description below. Other features will be apparent from the description and drawings, and from the claims.

### BRIEF DESCRIPTION OF THE DRAWINGS

FIG. 1 shows an example of a user interface that can be used to implement the techniques described here.

FIG. 2 shows an example of another user interface that can be used to implement the techniques described here.

FIG. 3 shows an example of yet another user interface that can be used to implement the techniques described here.

FIG. 4 shows an example of a flowchart for an example process for modifying a geographic route, consistent with the techniques described here.

FIG. 5 shows an example of a computer device and a mobile computer device that can be used to implement the techniques described in FIGS. 1-4.

FIG. 6 shows an example of a system that that can be used to implement the techniques described in FIGS. 1-5.

Like reference symbols in the various drawings indicate like elements.

### DETAILED DESCRIPTION

Users may enter search queries in a graphical user interface to search for directions, such as driving directions, walking directions, biking directions, public transit routes, or some combination thereof. Route descriptions for transit systems may consist of a series of maneuvers (e.g., take train ABC to Shinjuku, walk via exit to bus stop K, take bus 274 towards Shibuya). Each maneuver may have a number of static attributes, such as a mode (e.g., bus, train, subway), an operator (e.g., New York MTA, Amtrak), additional fees, outdoor walking, or level changes (e.g., lifts, escalators, stairs). Maneuvers can also have real-time attributes (such as delays, overcrowding, weather conditions). Yet, some users may not want attributes for geographic searches to be pre-specified as a set prior to each search, for example when entering a search query.

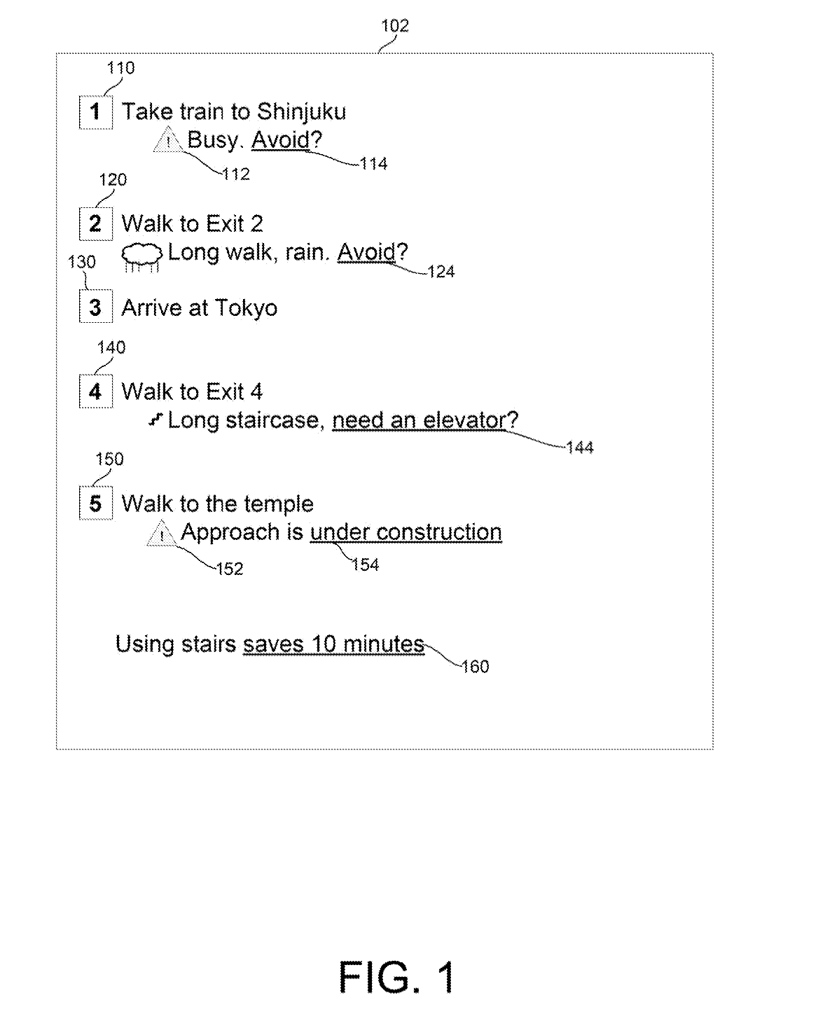

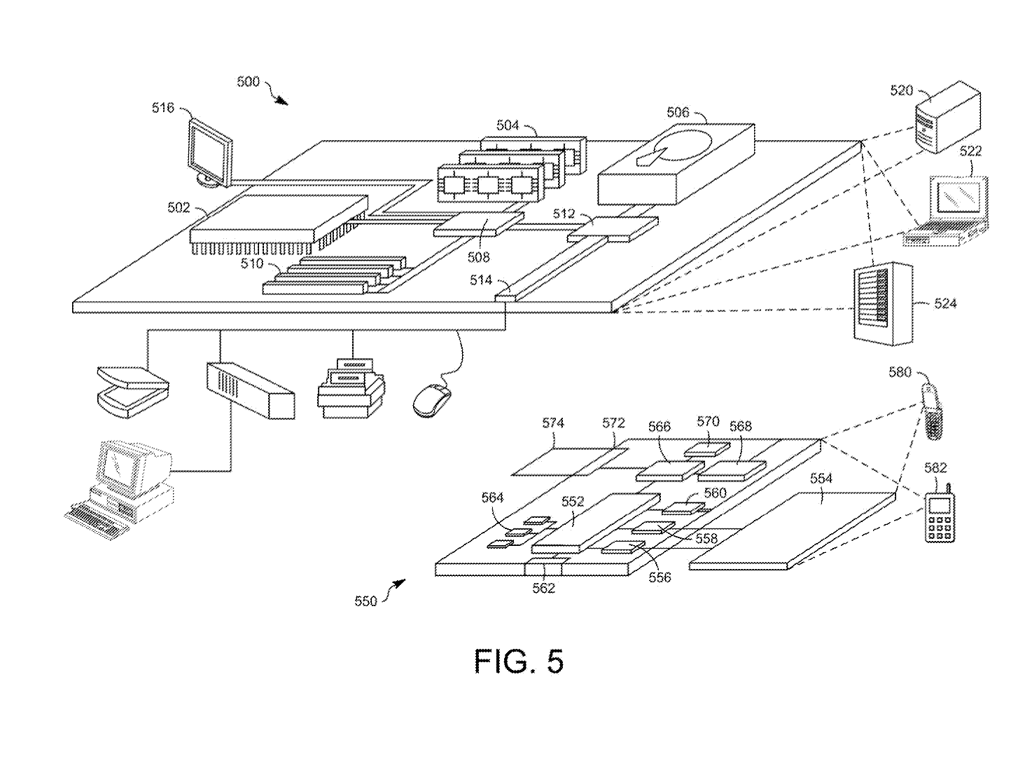

FIG. 1 shows an example of a user interface that can be used to implement the techniques described here. User interface 102 may be presented in any display(s) of a computing device. Various examples of displays are described in more detail below with respect to FIG. 5. User interface 102 includes a route description that consists of a series of maneuvers 110, 120, 130, 140, and 150. The series of maneuvers may have been calculated based on a search query by a user (not shown in FIG. 1). Each maneuver 110, 120, 130, 140, and 150 may include a number of attributes. For example, maneuver 110 includes attributes 112 and 114. Attribute 112 indicates that maneuver 110, which corresponds to “Take train to Shinjuku,” is “Busy.” Maneuver 110 may be busy due to crowding on a particular train line or another delay along the train line. The information that helps the system determine that maneuver 110 is “busy” may be based on real-time data. Such real-time data may be based on data from a transit system feed, such as congestion levels, frequency changes, or accidents. A user may have the option to click on or otherwise select a selectable attribute 114 “Avoid” to avoid maneuver 110. If the user selects attribute 114, the system may automatically recalculate a route including a new series of maneuvers to avoid maneuver 110. Any suitable graphical representation of the attributes can be used, including text and/or icons.

In some implementations, a query can include a time and date (e.g., Friday at 5:00 PM) and information about congestion levels, traffic, or delays (e.g., that maneuver 110 is “busy”) may be based on historical data for an area (e.g., a vicinity of maneuver 110 on Friday afternoons). The time or date may be automatically determined, in some implementations, without user input. Alternatively or additionally, information about congestion levels, traffic, or delays may be based on scheduled work on roads, subway elevators, escalators, trains, buses, intersections, etc., which may be stored at a server or database. Congestion levels may also be determined based on a real-time determination of an average or actual number of people in a certain area (e.g., a number of people walking down a street, biking down a path, or standing at train station or subway stop at a given time), for example using data from mobile phones, if users opt to provide such information. In some implementations, congestion levels (e.g., of a train, subway, bus, or other public transit system) may be determined from information feeds (e.g., real-time, periodic, or historical information feeds) from a transit system, such as the transportation planning server described below with respect to FIG. 5.

Similarly, maneuver 120, “Walk to Exit 2,” includes a selectable attribute 124 “Avoid”, to avoid a “long walk, [due to] rain.” If the user selects attribute 124, the system may automatically recalculate the route including a new series of maneuvers to avoid maneuver 120. Weather forecast information such as “rain” near the a vicinity (e.g., a radius of 1 mile) of a maneuver such as maneuver 120 may be based, for example, on real-time data for an area (e.g., the radius, or a zip code) or a forecast for the vicinity of one of the maneuvers (such as maneuver 120). Information about a flood or a possible flash flood in a weather forecast may be used to suggest alternate routes to a user, for example to avoid a river. Weather forecast information may also be used to provide a “scenic route” option(s). In some implementations, user interface 102 may also include information about various local businesses near a maneuver.

Maneuvers may be associated with more than one selectable attribute. For example, maneuver 140 “Walk to Exit 4” includes information that a “Long staircase” is associated with the maneuver 140, and provides a selectable attribute “need an elevator” 144. If the user selects attribute 144, the route may be recalculated automatically upon the selection of selectable attribute 144 to exclude maneuver 140 or to include an elevator in the maneuver. The system may determine a time period relevant to a user's search and provide data relevant to constraints during a specified time suggested by a user or automatically supplied by the system, for example, after 8pm, or between noon and 3 pm, within the next 20 minutes, etc.

As discussed above, maneuvers may be associated with both static and real-time constraints. Static constraints may be objective. For example, static constraints may related to a mode (e.g., bus, train, subway), an operator (New York MTA, Amtrak), fees, outdoor walking, level changes (lifts, stairs, elevators). Static constraints may also be subjective, such as the example shown for maneuver 150, which includes icon 152 with selectable attribute “approach is under construction” represented by link 154. In the example shown in FIG. 1, icon 152 includes text with a selectable link 154, which a user may select to view more information about the constraint(s) associated with the maneuver (e.g., in a website, pop-up window, etc.).

User interface 102 may also include information about optimal routes or various benefits of particular maneuvers. For example, user interface 102 includes a selectable link showing that “Using stairs saves 10 minutes” 160. The user may select link 160 to view additional information about time constraints for particular routes, or to specify other alternatives to maneuvers, such as removing stairs from the series of maneuvers.

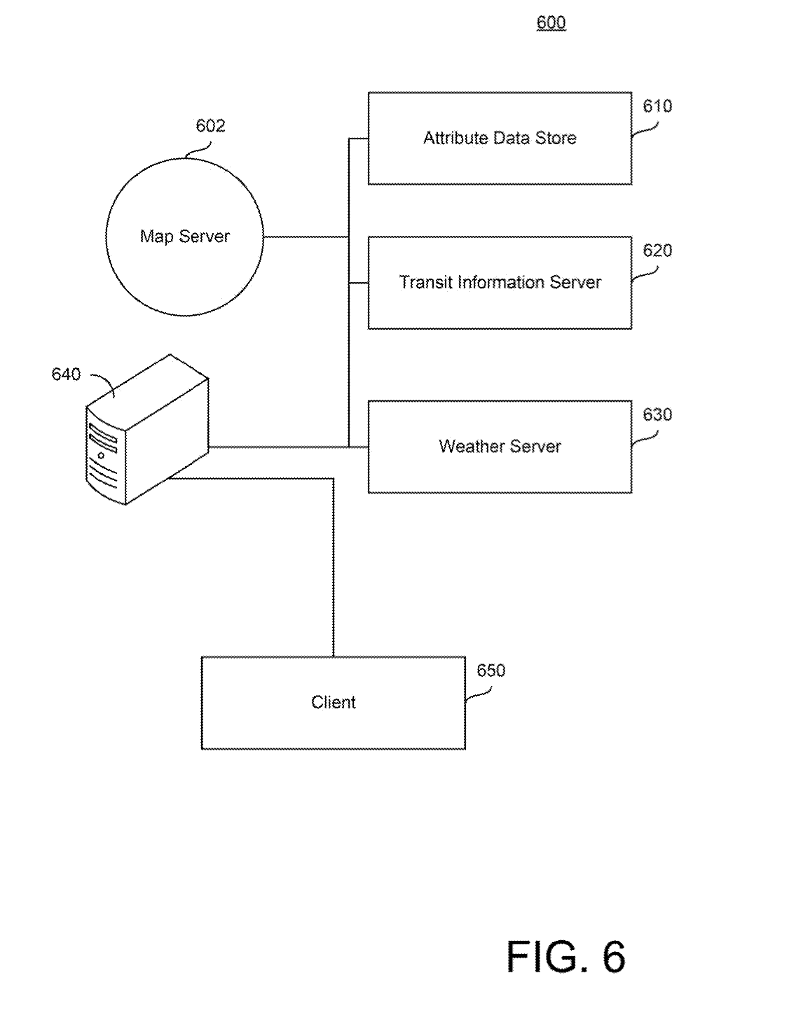

The particular depiction of user interface 102 is merely for illustration, and the use of specific text and graphics shown in user interface 102 (e.g., icon 112, links 114, 124, etc.) are meant as examples only, and may be rearranged, added, or deleted. Other implementations of user interface 102 may utilize other types of selectable icons, drop-down menus, check boxes, buttons, or sliders. Further, user interface 102 may be configured to receive touch-screen gestures, such as swipes, instead of or in addition to selectable attributes 114, 124, 144, and 154. For example, a user may check an “avoid” checkbox to avoid a route instead of selecting a link. Or, a user may simply swipe a visual area of user interface 102 using a touch screen (e.g., the area surrounding maneuver 110) to avoid a particular maneuver (e.g., 110) in a route. As yet another example, a user may select a selectable attribute (e.g., 114) to view a drop down menu including alternate options for the associated maneuver (such as maneuver 110). For example, upon selecting selectable attribute 114, a drop down menu may display an option to take a Bus to Shinjuku or a Taxi to Shinjuku. After selecting an option in the drop down menu (not shown), user interface 102 may automatically update or refine the route to adjust to a new selected option. The update may occur immediately after a user selects the option, or may occur after a user enters another input, such as clicking on an “accept” button in a pop-up window. The route may be refined using a central server in conjunction with other servers and/or data stores, which are described in more detail below with respect to FIG. 6, to determine an alternate or new route to avoid a selected attribute. For example, if a user selects the option to Avoid (114) the Train to Shinjuku, the central server may refine the route to reflect the user's selection, for example by presenting an option to take a bus to Shinjuku instead.

Alternatively or additionally, user interface 102 may incorporate geographic maps, animation such as Flash, video, sounds, pop-up windows, toolbars, search boxes, expandable menus, thumbnail images, blogs, advertisements, image galleries, social media features such as “like” buttons, comments, or reviews, toggled content, tabbed content, slideshows, column layouts, or various other graphical features or text.

User interface 102 may be displayed within a web browser, for example as part of a web page or web application, or may be displayed as a portion of a stand-alone application, for example on a mobile device.

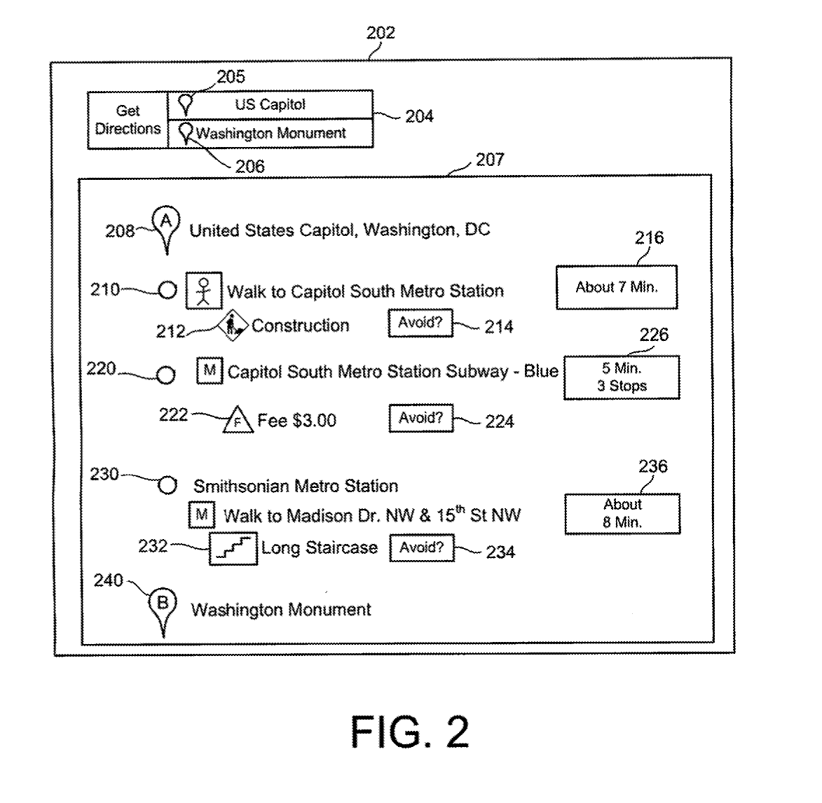

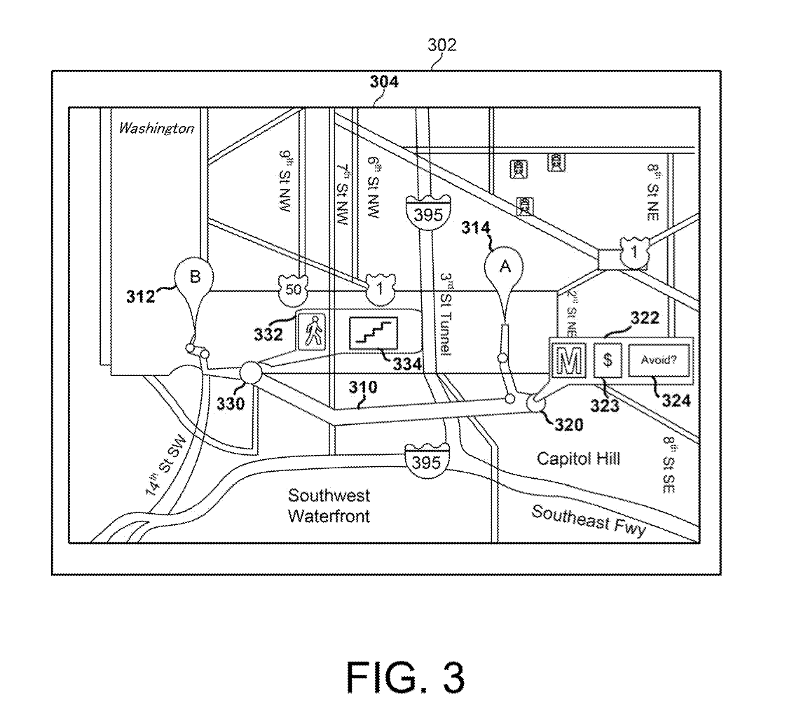

User interface 102 does not require a user to pre-select any “advanced features” or constraints in a search query. For example, a user does not need to pre-specify constraints such as “need an elevator” until the user sees that stairs may be part of a route given as a result of a search query entered by the user. As another example, a user does not need to specify to avoid “busy” or “crowded” areas until the user sees that a particular maneuver (e.g., maneuver 110) may be crowded or busy. Thus, a user may judge constraints for a route based on concrete or real-time information. As another example, while a user may in general want to avoid extra fees, such as through-operator charges, the user may accept an extra fee if it is less than a certain amount, after seeing that the route saves 20 minutes over an alternate route. As such, with user interface 102, a user does not a priori exclude options that may be at the fringes of his or her acceptance range. Additional examples of user interfaces that may be used to implement the techniques described here are shown in FIGS. 2 and 3.

FIG. 2 shows an example of another user interface that can be used to implement the techniques described here. As shown in FIG. 2, a user interface 202 includes a search query 204, for public transit directions from the “US Capitol” 205 to the “Washington Monument” 206. The user interface includes a calculated route 207, which may have been calculated based on the search query. The route 207 includes a beginning point 208, and end point 240, and a series of maneuvers 210, 220, and 230, which have been calculated based on the search query 204. Each maneuver 210, 220, and 230 may be associated with a static or real-time condition. In various implementations, only certain maneuvers may have associated static or real-time conditions.

Maneuver 210, “Walk to Capitol South Metro Station,” includes a condition that “Construction” 212 is occurring at or near maneuver 210. Maneuver 210 also includes a time “About 7 mins” 216 to indicate the estimated time it will take a person to complete the maneuver 210. Selectable attribute 214 “Avoid” gives the user the option to avoid maneuver 210.

Maneuver 220, “Capitol South Metro Station” “Subway—Blue—Metrorail Blue Line towards Franconia Metro,” includes a condition 222 that a fee is required. Selectable attribute 224 “Avoid” gives the user the option to avoid maneuver 220. Maneuver 220 also includes time and subway stop information 226 “5 mins, 3 stops” to indicate the estimated time it will take a person to complete the maneuver 220.

Maneuver 230, “Smithsonian Metro Station” “Walk to Madison Dr NW & 15^{th} St NW, Washington D.C. 20001,” includes a condition 232 that a long staircase represented by selectable attribute 234 is required. Selectable attribute 234 “Avoid” gives the user the option to avoid maneuver 230. Maneuver 230 also includes time 236 “About 8 mins” to indicate the estimated time it will take a person to complete the maneuver 230.

The user interface, attributes, text, and icons shown in FIG. 2 are merely for illustration, and may be rearranged, reconfigured, deleted, or modified. For example, any or all attributes or text may be selectable.

FIG. 3 shows an example of yet another user interface that can be used to implement the techniques described here. As shown in FIG. 3, a user interface 302 includes a map 304 including a route 310 generated after a search query (such as search query 204 shown in FIG. 2). The route 310 includes the series of maneuvers (such as 210, 220, and 230, from FIG. 2), in a visual map format. In various implementations, user interface 302 may be displayed alongside, concurrently with, instead of, or separate from user interface 202. For example, a user may have the option to display both a map and text depicting a route or options related to the route, a map alone, or text alone. A user of a mobile device, for example, may only wish to see a map at one time in the graphical user interface, and the user may select an option to see text at another time, for example due to limited screen size on the mobile device. As another example, a user of a desktop computer may wish to see both a map and a text description of a route at the same time in the user interface. The user interfaces described herein are fully customizable to allow for such modifications by users, to reflect their preferences. In some implementations, the system may automatically determine a type of device (e.g., mobile, tablet, desktop) or application (e.g., native or web browser) being used, and may modify the user interface accordingly. For example, the system may automatically determine that a user is viewing a map on a mobile device, and may therefore present only a map with selectable icons, without a corresponding list of text showing each maneuver.

The route 310 may include icons 312 and 314 that correspond to the beginning and end points of the route 310. The route 310 may also include selectable visual attributes 320 and 330 that are associated with the maneuvers 220 and 230. Icon 320 may correspond to maneuver 220, “Capitol South Metro Station” “Subway—Blue—Metrorail Blue Line towards Franconia Metro.” When a user selects or hovers over icon 320, the user may see (e.g., in a pop-up window 322) additional information about the maneuver, such as an icon 323 representing the condition that a fee is required, selectable attribute 324 “Avoid”, and/or time and subway stop information. Similarly, icon 330 may correspond to maneuver 230, “Smithsonian Metro Station” “Walk to Madison Dr. NW & 15^{th} St NW.” When a user selects or hovers over icon 330, the user may see (e.g., in a pop-up window 332) additional information about the maneuver, such as the condition that a long staircase represented by selectable attribute 334 is required, or a selectable attribute “Avoid”, and/or time “About 8 mins” (not shown in FIG. 3).

The user interface, attributes, text, and icons shown in FIG. 3 are merely for illustration, and may be rearranged, reconfigured, deleted, or modified. For example, any or all attributes or text may be selectable. Additionally, in some implementations, any of the user interfaces shown in FIGS. 1-3 (e.g., user interfaces 102, 202, and 302) may be combined into one single user interface (e.g., to display both a map and a text description of a route at the same time).

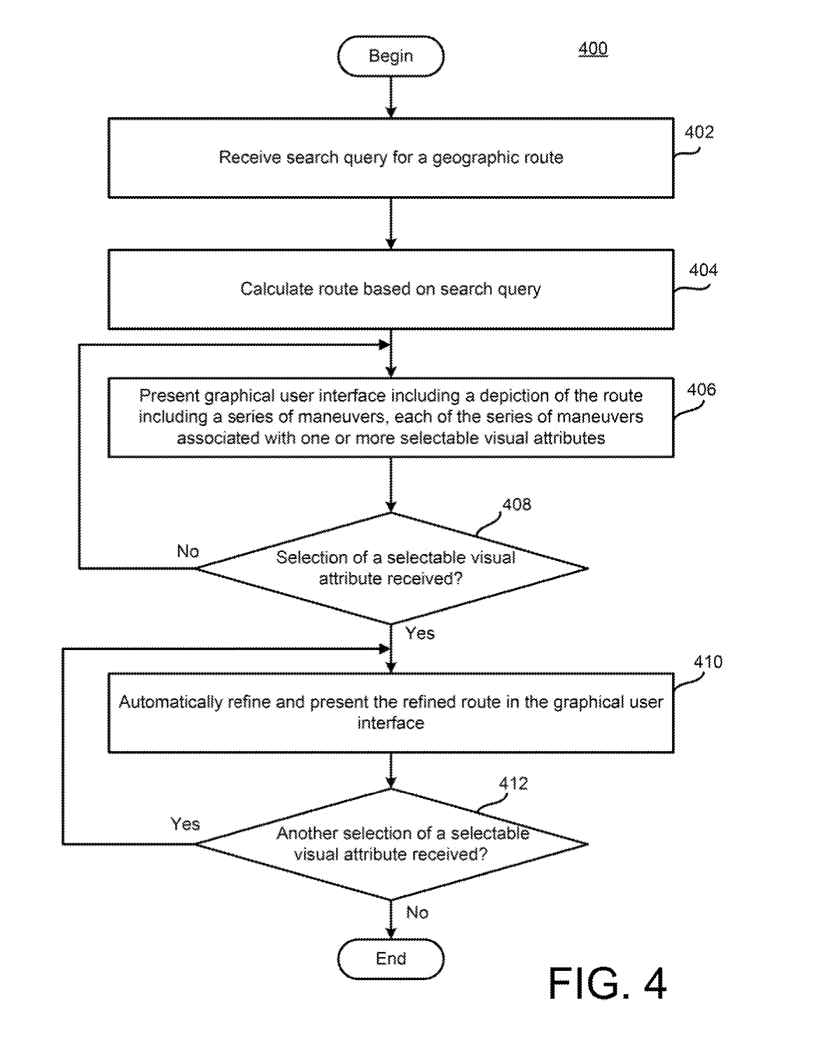

FIG. 4 shows an example of a flowchart for an example process for modifying a geographic route, consistent with the techniques described here. Process 400 may be performed in part by a server or a processor of a computer device, which are described in more detail below with respect to FIG. 5. As shown in FIG. 4, a computing device may receive a search query for a geographic route (402), such as query 204 described above with respect to FIG. 2. The device may calculate a route based on the search query (404). The device may present a graphical user interface (e.g., user interface 102 as shown in FIG. 1) including a depiction of the route, including a series of maneuvers. Each of the maneuvers may be associated with one or more selectable visual attributes (406), such as those shown in FIGS. 1-3. Next, process 400 determines if a selection of one of the selectable visual attributes is received (408). For example, a user may select avoid link 114, as shown in FIG. 1, by clicking on the link with a mouse, swiping a touch screen, or selecting a key on a keypad of a mobile device. If the device determines that a selection of one of the selectable visual attributes is received (408, yes), then the device may automatically refine the route (for example, by submitting a new query to a server based on the selection, and receiving a new route in response to the query) and present the refined route in the graphical user interface (410). If a selection of one of the selectable visual attributes is not received (408, no), the process 400 may continue to present the graphical user interface (e.g., without any modification to the route). In some implementations, refining the route may include responding to a new query submitted by a client device.

After presenting the refined route in the graphical user interface, process 400 determines if another selection of a selectable visual attribute is received (412). For example, a user may select avoid link 124, as shown in FIG. 1, to avoid a long walk in the rain. If no selection is received, (412, no), the process may end. If a selection is received, the process may return to step 410 to automatically refine the route again, based on the selection. Automatically refining the route may include automatically generating a new route in response to another selection of a selectable visual attribute (e.g., generating a route to avoid a long staircase in response to a selection of attribute 144 shown in FIG. 1.)

Process 400 does not require the particular order shown, or sequential order, to achieve desirable results. In addition, other steps may be provided, or steps may be eliminated, from process 400. For example, steps 402 and 404 may be deleted, or the process 400 may iterate over any number of selections of visual attributes and refined routes. Alternatively or additionally, a user may make selections of numerous selectable visual attributes at the same time before the route is automatically refined. For example, a user may wish to avoid all maneuvers that require fees or staircases, before refining the route.

FIG. 5 shows an example of a generic computer device 500 and a generic mobile computer device 550, which may be used with the techniques described in FIGS. 1-4. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI (e.g., user interface 102, 202, or 302) on an external input/output device, such as display 516 coupled to high speed interface 508. In other implementations, multiple processors and/or multiple buses may be used, as appropriate, along with multiple memories and types of memory.

Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers (such as map servers, transit data servers, etc.). It may also be implemented as part of a rack server system 524. In addition, it may be implemented in a personal computer such as a laptop computer 522. Alternatively, components from computing device 500 may be combined with other components in a mobile device, such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. For example, a special purpose mapping program may provide routing options based on geographic searches entered by a user, and may utilize map data and other data (e.g., transit data, weather data) provided by one or more servers or databases connected to device 500, for example.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer.

Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. For example, users may touch or swipe a touch-screen to provide input to a device without requiring the use of a keypad, mouse, or pointer.

The systems and techniques described here can be implemented in a computing system that includes a back end component (e.g., as a generic data server, map server, or transit data server), or that includes a middleware component (e.g., an application server), or that includes a front end component (e.g., a client computer having a graphical user interface such as user interface 102, 202, or 303, or a web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As examples, a map server may communicate with a mobile (client) device to provide maps and route planning for the client device, as described above.

FIG. 6 shows an example of a system that that can be used to implement the techniques described in FIGS. 1-5. System 600 includes a map server 602, an attribute data store 610, a transit information server 620, a weather server 630, a central server 640, and a client 650. One skilled in the art will recognize that any number of servers and/or clients may be configured in system 600, and the illustrated servers and clients are illustrative examples only.

Map server 602, which may represent one or more servers or data stores, may provide data for and calculations to determine geographic routing options based on search queries entered by users into a GUI (e.g., user interface 102, 202, or 302 shown in FIGS. 1-3) of a client 650 or of any computing device. Map server 602 may calculate, generate, and refine geographic routes in response to search queries for walking, biking, driving, or public transit directions, for example. Map server 602 may utilize publicly available data and other map data stored in a remote database or server (such as attribute data store 610, transit information server 620, or weather server 630) to calculate, generate, and refine the geographic routes.

The map server 602 may provide searchable, pannable mapping tools for route planning such as driving, public transit, walking, and biking Such tools may be executed in JavaScript and XML, as examples. Additionally, map server 602 may generate maps of streets, public transit systems, walking paths, bike trails, hiking trails, and other locations all over the world. Map server 602 may be utilized in conjunction with one or more data stores that provide data for street views, satellite views, aerial views, traffic information, weather information, photos, models, business information, and webcam views of various locations. Such data may include static and/or real-time conditions.

For example, map server 602 may include or communicate with an attribute data store 610. Attribute data store 610 may store information regarding attributes such as the attributes 112, 114, 124, 144, 152, 154 depicted in FIG. 1. Map server 602 may communicate with attribute data store 610 to determine if certain maneuvers, such as maneuvers 110, 120, 130, 140, and 150 shown in FIG. 1, are associated with any attributes stored in attribute data store 610. Attribute data store 610 may periodically update any attributes to reflect current or real-time conditions, as well as static conditions, associated with various geographic locations, transit routes, or maneuvers. For example, attribute data store 610 may store data that the Capitol South Metro Station is under construction, as described above with respect to FIG. 2. Other implementations are contemplated. For example, attributes may be retrieved from other local or remote services not depicted in FIG. 6, such as social networks, traffic databases, or other services. Attribute data store 610 may also communicate with transit information server 620 and weather server 630 to retrieve and update attributes (such as traffic or weather conditions that may affect a geographic transit route, as described above with respect to FIGS. 1-4.)

A transit information server 620 may connect with the map server 602 to provide data (e.g., real time data) about conditions related to certain public transit systems. For example, the transit information server 620 may store data related to accidents, delays, or crowding on various subways or buses in one or more public transit systems, or traffic conditions on roads or train tracks that may affect a public transit system. Transit information server 620 may provide such data to map server 602 automatically, for example on a periodic basis such as once a week, or upon request by map server 602.

Weather server 630 may also connect with map server 602 to provide real-time weather data on conditions related to various geographic locations. Weather server 630 may provide such data to map server 602 automatically, for example on a periodic basis such as every day at 12:00 am, or upon request by map server 602. The real-time transit data and real-time weather data may be utilized by the map server 602 to provide conditions related to maneuvers for geographic routes, for example as described above with respect to FIGS. 1-4. In some implementations, the weather server 630 may also communicate with transit information server 620, via a network.

As another example, the transit information server 620 may combine the latest agency data with the power of mapping tools. The transit information server 620 may integrate transit stop, route, schedule, and fare information to make trip planning quick and easy for users. The transit information server 620 may communicate with transit agencies around the world, in various languages, and may be compatible with screen readers for the visually impaired. The transit information server 620 may also provide tools that are available on mobile devices, such as mapping applications or web applications, for example.

Central server 640 may also communicate with map server 602, attribute data store 610, transit information server 620, weather server 630, and client 650, for example via a network. In some implementations, central server 640 may also store information in a database associated with, or accessible via, a user account if users have opted to allow such storage. Such information may include, for example, user profile data, previous user searches for geographic routes, preferences, geographic location, or other data, with user consent.

Central server 640 may also communicate with one or more clients 650, which may be used by members of the public seeking to search for geographic transit routes, for example. Such communication may occur via the use of a web application, web browser, native application, or other program.

A number of implementations have been described. Nevertheless, it will be understood that various modifications may be made without departing from the spirit and scope of the invention. For example, central server 640 may include map server 602 and attribute data store 610 within central server 640. As another example, in certain implementations, client 650 may communicate directly with map server 602, transit information server 620, weather server 630, etc. on a real-time basis, for example via a web browser or other application, without having to communicate with central server 640. As yet another example, any number of clients may communicate with each other and with server 640, for example to share information about routes and refined routes.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Any portion of the apparatus and/or methods described herein may be combined in any combination, except mutually exclusive combinations. The implementations described herein can include various combinations and/or sub-combinations of the functions, components and/or features of the different implementations described.

1. A method for modifying a geographic route from a starting location to a destination location, comprising:
responsive to a search query for the geographic route, presenting, using a processor of a computing device, a graphical user interface including a depiction of a route including a plurality of sequential maneuvers from the starting location to the destination location, at least one of the plurality of sequential maneuvers being associated with one or more selectable visual attributes,
wherein the one or more selectable visual attributes are associated with predetermined attributes not included in the search query,
wherein the predetermined attributes include static or real-time conditions;
automatically retrieving a refined route upon a selection of a first selectable visual attribute of the one or more selectable visual attributes, the refined route having a maneuver of the plurality of sequential maneuvers corresponding with the first selectable visual attribute replaced with one or more different maneuvers; and
upon automatically retrieving the refined route, presenting the refined route in the graphical user interface.

2. The method of claim 1, wherein the real-time conditions include at least one of: a weather condition, a congestion level, or a delay.

3. The method of claim 1, wherein the static conditions include at least one of: a mode, a level change, a fee, or a track condition for a local public transit system.

4. The method of claim 1, wherein the real-time conditions are automatically updated in the graphical user interface after a predetermined period of time.

5. The method of claim 1, wherein each of the predetermined attributes occurs within a predefined radius of an associated one of the plurality of sequential maneuvers.

6. The method of claim 1, wherein the refined route is displayed in the graphical user interface without additional input from a user.

7. The method of claim 1, further comprising:
automatically further refining the refined route upon a selection of a second selectable visual attribute of the one or more selectable visual attributes; and
upon automatically further refining the refined route, presenting the further refined route in the graphical user interface.

8. The method of claim 1, wherein the depiction of the route includes a map displaying the plurality of sequential maneuvers.

9. The method of claim 8, wherein the plurality of sequential maneuvers are concurrently displayed in a text format adjacent to the map.

10. The method of claim 1, wherein the selectable visual attributes are selectable by at least one of: a drop down menu, a button, a slider, or a touch-screen gesture.

11. (canceled)

12. (canceled)

13. The method of claim 1, wherein the route is calculated without including any predetermined constraints selected by a user.

14. The method of claim 1, wherein the selectable visual attributes are graphical icons.

15. The method of claim 1, wherein each of the one or more selectable visual attributes include an option to exclude a type of static or real-time condition associated with the one or more selectable visual attributes.

16. The method of claim 1, wherein the plurality of sequential maneuvers include a maneuver corresponding with a public transit system.

17. The method of claim 16, wherein the static or real-time conditions depend on a type of the public transit system.

18. The method of claim 16, wherein the computing device is a mobile device.

19. A non-transitory computer readable medium having recorded and stored thereon instructions that, when executed by a processor of a computer system, cause the computer system to:
submit, to a server, a search query for a geographic route from a starting location to a destination location;
receiving a route from the server in response to the search query;
display, using a processor of the computing device, a graphical user interface including a depiction of the route including a plurality of sequential maneuvers from the starting location to the destination location, each maneuver of the plurality of sequential maneuvers being associated with one or more selectable visual attributes,
wherein the one or more selectable visual attributes are associated with predetermined attributes not included in the search query,
wherein the predetermined attributes include static or real-time conditions;
submit a second search query to a server, the search query including instructions to refine the route in response to selection of a first selectable visual attribute of the one or more selectable visual attributes; and
receive a refined route from the server in response to the second search query, the refined route having a maneuver of the plurality of sequential maneuvers corresponding with the first selectable visual attribute replaced with one or more different maneuvers; and
display a depiction of the refined route in the graphical user interface.

20. A system comprising:
a display;
a memory configured to store executable code; and
a processor operably coupled to the memory, the processor configured to execute the code to:
in response to a search query for a geographic route, present on the display a graphical user interface including a depiction of a route including a plurality of sequential maneuvers from a starting location to a destination location, each maneuver of the plurality of sequential maneuvers being associated with one or more selectable visual attributes,
wherein the one or more selectable visual attributes are associated with predetermined attributes not included in the search query,
wherein the predetermined attributes include static or real-time conditions;
automatically retrieve a refined route in response to selection of a first selectable visual attribute of the one or more selectable visual attributes, the refined route having a maneuver of the plurality of sequential maneuvers corresponding with the first selectable visual attribute replaced with one or more different maneuvers; and
upon automatically retrieving the refined route, present the refined route in the graphical user interface.

21. The method of claim 1, wherein:
a first maneuver of the plurality of sequential maneuvers corresponds with a first mode of transportation; and
a second maneuver of the plurality of sequential maneuvers corresponds with a second mode of transportation, the second mode of transportation being different than the first mode of transportation.

22. The non-transitory computer readable medium of claim 19, wherein:
a first maneuver of the plurality of sequential maneuvers corresponds with a first mode of transportation; and
a second maneuver of the plurality of sequential maneuvers corresponds with a second mode of transportation, the second mode of transportation being different than the first mode of transportation.

23. The system of claim 20, wherein:
a first maneuver of the plurality of sequential maneuvers corresponds with a first mode of transportation; and
a second maneuver of the plurality of sequential maneuvers corresponds with a second mode of transportation, the second mode of transportation being different than the first mode of transportation.
